(19) United States
(12) Patent Application Publication
(10) Pub. No.: US 2015/0260614 A1
(43) Pub. Date: Sep. 17, 2015

(54) METHOD AND SYSTEM FOR MONITORING ROAD CONDITIONS

(71) Applicant: Lars FORSLOF, Ljusdal (SE)

(72) Inventor: Lars Forslof, ljusdal (SE)

(73) Assignee: Roadroid AB, LJUSDAL (SE)

(21) Appl. No.: 14/436,592

(22) PCT Filed: Oct. 18, 2013
(86) PCT No.: PCT/SE2013/000160

§ 371 Date: Apr. 17, 2015

Related U.S. Application Data
(60) Provisional application No. 61/715,870, filed on Oct. 19, 2012.

(51) Int. Cl. G01M 99/00; G01B 21/30

(52) U.S. Cl. CPC G01M 99/00; G01B 21/30

(57) ABSTRACT

A method for monitoring road conditions includes measuring a vehicle movement quantity associated with a present road condition. A respective position at which the measuring was performed is recorded. A road condition class is assigned to each of the positions by comparison with type calibration data. The type calibration data is pre-defined relations between vehicle movement quantities and road condition classes for a specific type of measuring unit and for a specific type of vehicle. The positions and assigned road condition classes are stored in a road condition database. A consolidated road condition class is determined for a target road section, by forming a distribution of stored road condition classes for positions within the target road section and selecting the consolidated road condition class to be representative for the distribution of road condition classes. The consolidated road condition class for the target road section is presented.

### BACKGROUND

There is a need among private and public owners of roads, railroads and bicycle roads, as well as companies supplying maintenance services to these owners, to continuously maintain an objective overview of the condition of their respective road networks. They also need to objectively monitor both the immediate effects of road maintenance activities and the effects over time of different alternative approaches. This has so far been difficult, due both to the prohibitive costs of frequently using specialized road condition measuring vehicles and to the lack of a modern and flexible standard for road quality presentation and comparisons. The currently used road quality standard, IRI—International Roughness Index, faces common and important complaints, e.g. that it is speed dependent and mostly measured in fixed lengths which makes it hard to scale up, to present on maps and to refer to road links in modern road geometry databases. For navigation and Road Condition Routing Services (RCRS), it would be of very high interest to be able to provide private and professional road users with a Comfort Level at proposed routes.

In developing countries, road condition measuring vehicles are often not available at all, leaving subjective ocular road condition assessments as the only alternative, such having been proven to be both inconsistent and prone to undue influences from people who may gain from certain allocations of road maintenance resources. In developing countries it would also encourage development cooperation investors in infrastructure projects if they could remotely monitor the road quality development.

### SUMMARY

An object of the present invention is to provide a method and system for collecting and/or monitoring road conditions that is easy to accomplish with relatively simple means and which at the same time provides for scalability and general use.

A method for monitoring road conditions comprising in one embodiment the steps of:
a) measuring a vehicle movement quantity associated with a present road condition at a plurality of occasions, also referred to as sampling;
b) recording a respective position at which the measuring (sampling) was performed;
c) in certain embodiments assigning a measurement time to the position and assigned RCC
d) assigning a road condition class (RCC), out of a number of predefined RCCs, to the position;
e) in certain embodiments communicating the positions with assigned RCCs and assigned measurement times to a road condition database (RCD)
f) storing the positions with assigned RCCs and assigned measurement times in a road condition database (RCD); and
g) determining a consolidated RCC (CRCC), out of the predefined RCCs, for a target road section or road area
h) presenting the CRCC for the target road section or road area

Steps a-d, and in certain embodiments step e or step f, are performed by a measuring unit mounted at a vehicle in motion.

In step d, the (sampled) vehicle movement quantities are compared with type calibration data to form the road condition class (RCC) assigned to the position. Type calibration data are pre-defined relations between vehicle movement quantities and road condition classes for the specific type of measuring unit and the specific type of vehicle being used.

Steps f-h may in different embodiments be performed by the measuring unit, by a computer system, by a computer program or by a computer program product.

In step g, the RCD is utilized to determine a consolidated road condition class (CRCC) for a target road section or a target area. This is done by forming a distribution of stored road condition classes within the road section or area and selecting a consolidated road condition class to represent the distribution of road condition classes. In one implementation, this selection is based on calculating a rounded weighted average of the distribution.

In step h, the position and measured road condition class, or consolidated road condition class for the target road section or area, may then be presented, for example graphically or in reports, or communicated to other databases or other computer systems.

One aspect of the present innovation is a system for monitoring road conditions comprising: at least one measuring unit, being mountable at a respective vehicle; and a road condition database server.

The measuring unit will at least have: a vehicle movement sensor: operable to measure a vehicle movement quantity associated with a present road condition; a positioning unit, operable to record a position at which the measurement is performed; a communication unit, operable to communicate data to said road condition database server.

The road condition database server will have at least a receiver for receiving data from the measuring unit(s), and a memory.

The system will be operable to assign a road condition class, out of a limited number of road condition classes, to a position, as earlier described based on measured vehicle movement quantities being compared with type calibration data; possibly to store a measurement time; store positions and assigned road condition classes and possibly a measurement time in a road condition database in the memory; and the road condition database server being further operable to determine and present a consolidated road condition class from a road condition distribution, as earlier described.

Another aspect of the present innovation is a computer program, which causes a processing circuitry to: obtain a plurality of positions and thereto assigned road condition classes; store positions and assigned road condition classes in a road condition database; determine a consolidated road condition class, for a target road section or a target area, by forming a distribution of stored road condition classes in the ways earlier described; and present the consolidated road condition class.

Yet another aspect of the present innovation is a computer program product on which a computer program is stored that when executed measure movements, records positions and assigns road condition classes as described earlier, and either communicates positions and road condition classes to a road condition database or stores these data in a road condition database where consolidated road condition data are obtained in ways earlier described, and different road condition data are presented for a target road section or a target area.

### DETAILED DESCRIPTION

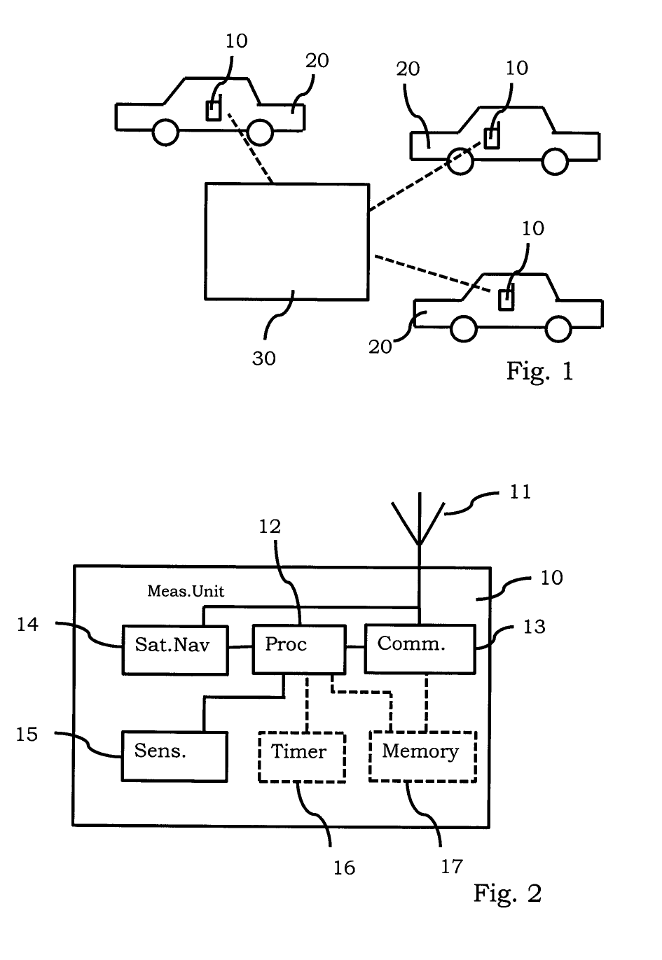

The present disclosure presents a method to monitor road quality by assigning roads with calibrated, objective and comparable Road Condition Classes (RCCs). This is done according to a fully scalable new standard for road quality, here denominated ‘The Roadroid Index’ (TRI). In one embodiment, schematically illustrated in FIG. 1, recorded positions obtained by a satellite-based navigation system are assigned RCCs and measurement times by one or more measuring units 10 mounted at normal vehicles 20 travelling on roads, railroads, bicycle roads, etc. are communicated to a Road Condition Database server 30.

The RCCs are assigned out of a number of predefined road condition classes, in one embodiment envisaged to be represented by the four integer values 1-4. For presentation purposes, the different RCCs in the range may also be assigned color codes, e.g.: 1=green=Good, 2=yellow=Satisfactory, 3=red=Unsatisfactory and 4=black=Poor. In alternative embodiments other number of RCCs is used. The predefined number of RCCs should preferably be selected considering data storage capacity, available transmission resources, accuracy in RCC assignment and presentation lucidity.

TRI on an aggregated level consists in one embodiment of both a RCC distribution for the level and a consolidated RCC (CRCC) for that level assigned as a single representation of the RCC distribution. An aggregated level can e.g. be road links in a road geometry, certain road sections, a part or all of a road network, a target area etc. The RCC distribution is in a particular embodiment represented by the percentage of road condition values, among all points considered on the level, that adheres to each of the respective RCC integer numbers in the range, e.g.: % ‘green’ points (1s), ‘yellow’ points (2s), %′red′ points (3s) and %′black′ points (4s) if four RCCs are used. In other embodiments, other types of RCC distributions measures can be used. The CRCC for an aggregated level is in one embodiment calculated as a weighted average of the RC distribution for the level (a real number that may be rounded to an integer for presentation purposes). In other embodiments, other types of averages or typical values can be used for expressing the overall RCC. An illustration of how CRCCs could be calculated in one embodiment with one choice of weights is presented below:

| | weights | | | | |
|---|---|---|---|---|---|
| | 1 | 1 | 1 | 3 | |
| No of RCCs | Green | Yellow | Red | Black | Total |
| Road Link 1.1 | 10 | 10 | 5 | 5 | 30 |
| Road Link 1.2 | 8 | 10 | 10 | 32 | 60 |
| Road Link 1.3 | 60 | 10 | 20 | 30 | 120 |
| TOTAL ROAD 3 | 78 | 30 | 35 | 67 | 210 |

| | Distribution | | | | | W. | |
|---|---|---|---|---|---|---|---|
| CRCC | Green | Yellow | Red | Black | Ave. | Av. | CRCC |
| Road Link 1.1 | 33% | 33% | 17% | 17% | 2, 2 | 2, 6 | Yellow |
| Road Link 1.2 | 13% | 17% | 17% | 53% | 3, 1 | 3, 6 | Black |
| Road Link 1.3 | 50% | 8% | 17% | 25% | 2, 2 | 2, 8 | Red |
| TOTAL | 37% | 14% | 17% | 32% | 2, 4 | 3, 0 | Red |
| ROAD3 | | | | | | | |

A measuring unit may in different embodiments be a smartphone or may consist of other equipment mounted to the vehicle for the purpose. In one embodiment, the measuring unit is a smartphone mounted in a fixed bracket to the vehicle and running a special program for the purpose. A measuring unit will need to include at least one sensor by which the road condition can be computed (typically an inertial sensor for vibrational sampling), and at least one GPS sensor for geographical positioning. Preferably, the measuring unit also comprises at least one time stamp device to decide the point in time when a measurement is made and at least one digital memory device.

A measuring unit will also need to include at least one digital processing device and at least one device to communicate data, preferably as being stored in the digital memory device, to an external computer server by direct or indirect means. The aforementioned parts of the measuring unit may preferably be combined into multi-function device(s) rather than separate devices. One non-exclusive example is the earlier mentioned smartphone equipped with the necessary functionalities. The measuring unit may in alternative embodiments also be dedicated equipment for this purpose. The measuring unit may in further alternative embodiments also carry further sensors, as well as recorders of complementary data/information such as voice recordings, pictures and video. One embodiment of a measuring unit 10 is schematically illustrated in FIG. 2. This embodiment includes a processing device 12, a satellite navigation device 14, a movement sensor device 15, a timing device 16, a digital memory device 17, a communication device 13 and an antenna device 11 for wireless communication.

Since the measurement units can be based on a relatively simple and inexpensive platform, a large number of units can be provided also by a limited budget. By in some embodiments attaching the measurement units to vehicles that are traveling a lot on various roads, e.g. post delivery vehicles, community service vehicles etc., large number of measurement points can be obtained. Such a crowd sourcing may provide a data base with extremely good accuracy and statistics both in position and time. In other embodiments, measuring units may be used by professional road staff for high precision purposes or for concurrent collection of complementary information by advanced sensors or other equipment.

Preferably, each combination of measuring unit type and vehicle type to be used will be calibrated to recognize the different predefined standard levels (RCCs) of road quality. The calibration is in one embodiment performed empirically in realistic situations, e.g. by test runs a certain number of times at a certain number of different speeds on a test track with a certain number of standardized obstructions. In alternative embodiments, calibration may be performed in a laboratory setting where all calibration vectors may be simulated. The measurement characteristics can in such a way be associated to the different RCCs. The division of measuring unit types and vehicle types is preferably made according to the obtained accuracy and repeatability in the calibration procedure.

For professional measuring of road condition, the use of measuring units that have been calibrated for the different vehicle types in a controlled environment has proven to give high repeatability across individual units/vehicles. To achieve this high repeatability, the calibration may result in specifications for a particular vehicle type and as an example, there are requirements put on the tire air pressure for certain vehicles. The alternative to calibrate each and every unit/vehicle would generate unnecessary costs and hassle, and probably in actual practice a lowering of calibration standards.

During operation, the measuring unit collects in one embodiment sample vibrational data from inertial sensor(s), e.g an accelerometer or similar equipment, while the vehicle that carries it moves on the road, railroad or bicycle track. Preferably, this is performed at frequencies of at least 100 samples per second. Also preferably, it is performed at a predefined minimum speed. The measuring unit analyses the data sampled during an assigned time period, typically 1 second, and defines the RCC for the geographical position by assigning a predefined RCC based on the analysis. The analysis method, which has been developed after experiences from years of research, takes into consideration type of vehicle and type of measuring unit/sensor. Different measuring units may have different sensors, e.g accelerometer sensors, that give different signals, different processing units, etc. Hence it is important that the different sensors, different software versions of processing units, etc. are tested and verified. Mounting in the vehicle is also important, and the measuring units should be mounted according to specific instructions in order to fulfil the requirements for fitting into a specific measuring unit/vehicle type calibration.

The RCC is preferably stored in the digital memory device together with a GPS coordinate. Preferably the stored information also comprises a time stamp, a speed value (supplied by the GPS sensor directly or calculated from GPS sensor data), and any other data of interest produced by the unit (RMS, Peak, etc.). The measuring unit may concurrently also collect recordings or other interesting information and store these in the digital memory with GPS coordinates and time stamps.

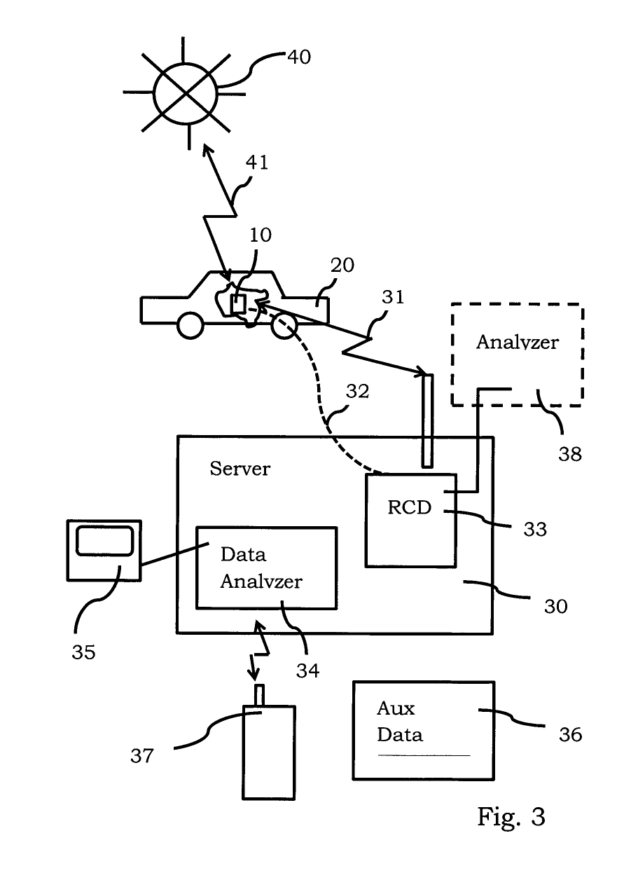

In one embodiment, schematically illustrated in FIG. 3, at certain times the collected RCCs, associated GPS coordinates and corresponding additional data, as well as any relevant and separately recorded information, are transferred from the measuring unit to a central computer server 32. From the computer server, this information is entered into a Road Condition Database (RCD) 33 which may also collect auxiliary road condition information from other sources 36. In one embodiment, the transferring of data may be performed continuously as soon as there are available data to send. In alternative embodiments, the data is transferred either at predetermined occasions or when a certain amount of data has been collected. In a presently preferred embodiment, the transfer is made by a wireless communication technique 31. However, in particular embodiments, transferring of data may also be performed by wired communication paths.

By using RCCs from calibrated measuring units 10, stored in the RCD 33, besides the simple retrieving of data associated with each set of single measuring point, also objective TRI information can be produced for any aggregate levels (single road links in any road geometries, specific stretches of roads consisting of multiple road links, whole road networks, for entire cities and even for entire country networks, etc.). The aggregate levels may also be divided in time or according to any other additional data. This scalability and flexibility is achieved by the configuration of the RCD, where individual measuring points are available.

TRI information may be presented in graphical format and in different kinds of reports 35, and/or stored in the RCD itself for fast access to more limited amounts of data. Comprehensive collection over time of TRI values in the RCD, makes it possible to present and compare objectively prepared and standardized TRI information in a number of different ways. Overview graphs and reports can be presented, and zooming in on problem areas can be done down to single road links or even to the RCC of single GPS coordinates. The distribution of RCCs can be studied on any aggregate level with the use of TRI's distribution component. Analysis can be made of a current road network for identification of prioritized activity areas, and evaluation of work performed can be done. As the TRI is correlated to IRI it is possible to import data to asset management systems as HDM (Highway Development and Management). Road deterioration over time can be monitored, as well as the effect of maintenance work over time. The interdependence between road deterioration and different environmental factors (frost, ground composition, etc.), maintenance materials used, maintenance methods used, etc. can be monitored and analyzed. Based on data and experiences from similar previous conditions, warnings can be issued for expected road problems (e.g. heat buckles). Communication between contractor and customer/road owner can be improved by the use of TRI information in different kinds of exchanges.

The above type of analysis is performed in a data analyzer (see FIG. 3). The data analyzer may in one embodiment be comprised in the central computer server together with the RCD 34. In other embodiments, the data analyzer can be provided by an external processor, connected to the RCD for retrieval of data 38. The data analyzer may in different embodiments be constituted as a distributed unit, with processing power from different sources. Road Condition comparisons can also be made between different road networks, with possibility to see both overall and distributed TRI ratings to analyze the composition of quality within the road networks.

The information richness will increase if TRI data in the RCD is combined with time- and GPS-stamped video/voice recordings, pictures, public complaints, etc. Complementary information in the RCD, collected by the measuring units or by other means, can easily be linked to the TRI information. This can e.g. include recorded comments or video on a certain stretch of road, pictures showing a certain problem, reported complaints from the public, etc. Such information will add considerably to the richness of information available from the RCD.

Comprehensive collection over time of RCCs and CRCCs into one or more RCD(s) will allow full overview of a road network, zooming in on problem areas, monitoring of road deterioration over time and monitoring of the effect of maintenance work. It will also allow better analysis of the interdependence of road deterioration with different environmental factors (frost, ground composition, etc.), maintenance materials used, maintenance methods used, etc. The information is also of high interest for navigation and Road Condition Routing Services (RCRS).

For navigation and routing purposes, the RC values create a whole new service. It is of great importance for a road user's choice to take the Road Condition into account. It's a comfort issue but it is also a road safety issue, especially for motorcyclists or driving on bumpy roads in combination with ice/black ice.

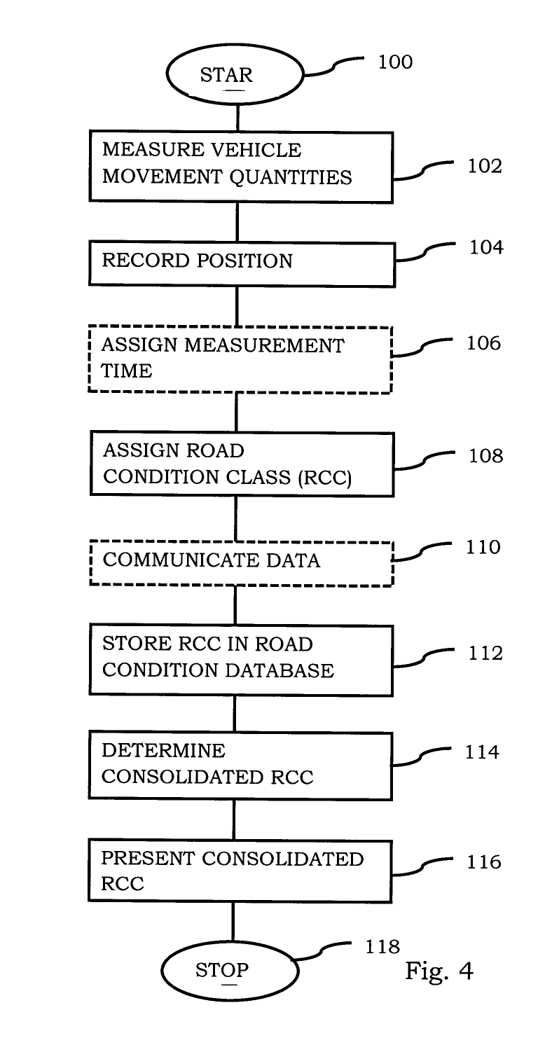

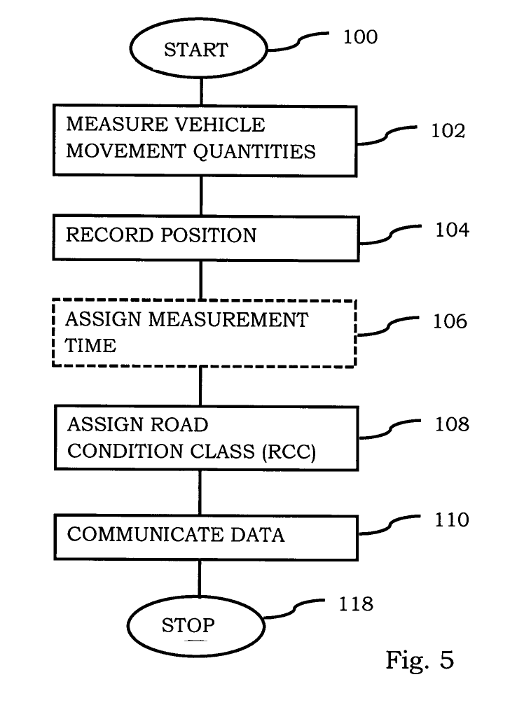

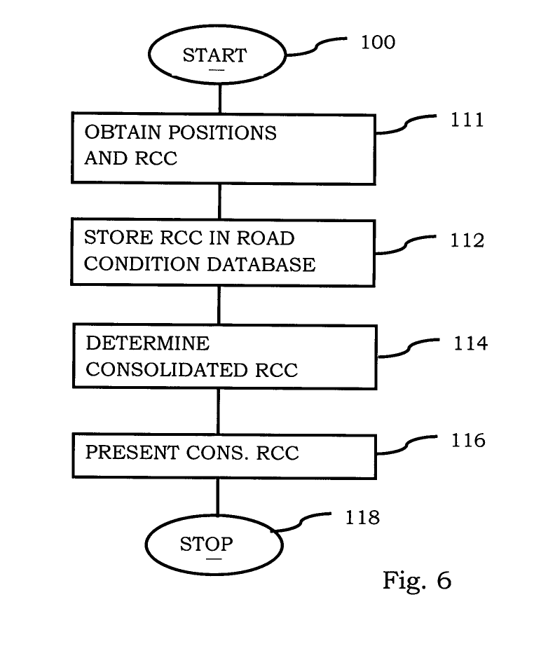

One preferred embodiment of the method comprises the steps (see FIG. 4) of:
measuring, by a measuring unit mounted at a vehicle, a vehicle movement quantity associated with a present road condition, at a plurality of occasions, also referred to as sampling 102;
recording, by the measuring unit, a respective position also referred to as a sampling position at which the measuring was performed for the plurality of occasions 104;
in some embodiments assigning a measurement time 106;
assigning a road condition class (RCC), out of a number of RCCs, to each of those (sampling) positions, by comparing the measured vehicle movement quantities of the plurality of occasions with type calibration data 108;
in some embodiments communicating positions with corresponding assigned RCCs and possibly measurement times to a road condition database server 110;
storing the positions and corresponding RCCs in a road condition database (RCD) 112;
determining a consolidated RCC (CRCC) for a target road section or a target area, by forming a distribution of stored RCCs for positions within the target road section or area and selecting the CRCC to be representative for that distribution of RCCs 114; and
presenting the CRCC for the target road section or target area 116.

With reference to FIG. 4, steps 102, 104, 108, and in certain embodiments steps 106, 110, 112, 114, 116 are performed by a measuring unit mounted at a vehicle in motion.

In step 108, the (sampled) vehicle movement quantities are compared with type calibration data to form the road condition class (RCC) assigned to the position. Type calibration data are pre-defined relations between vehicle movement quantities and road condition classes for the specific type of measuring unit and the specific type of vehicle being used.

Steps 110, 112,114 may in different embodiments be performed by the measuring unit, by a computer system, by a computer program or by a computer program product.

In step 114, the RCD is utilized to determine a consolidated road condition class (CRCC) for a target road section or a target area. This is done by forming a distribution of stored road condition classes within the road section or area and selecting a consolidated road condition class to represent the distribution of road condition classes. In one implementation, this selection is based on calculating a rounded weighted average of the distribution.

In step 116, the position and measured road condition class, or consolidated road condition class for the target road section or area, may then be presented, for example graphically or in reports and in certain embodiments combined with other information collected by the measuring unit or from external sources, or be communicated to other databases or other computer systems.

In one embodiment of the method, the position (recorded at step 104) and RCC (assigned at step 108) are stored in a memory in the measuring unit and the communication performed collectively for a plurality of positions and associated road condition classes.

In one embodiment of the method, the movement quantity (measured in step 102) is a quantity quantifying vibrations.

In one embodiment of the method, the step of recording a respective position 104 comprises positioning by use of a satellite-based navigation system.

In one embodiment of the method, a measurement time is assigned to each position and assigned road condition class 106, and this time is also stored in the memory, RCD and any other devices, as well as further processed and utilized in the further analysis and presentation.

In one embodiment of the method, the consolidated road condition class is determined 114 as a rounded off weighted average of the distribution of stored road condition classes.

One embodiment of the method includes the further step of providing a representation of the distribution of stored RCCs together with the presentation of the CRCCs.

One embodiment of the method includes the further step of determining a CRCC being repeated for different target road sections or target areas and/or optionally different target time periods, wherein the step of presenting and of providing are performed collectively for the different target road sections or target areas and/or optionally different target time periods.

A system for monitoring road conditions comprises: at least one measuring unit, being mountable at a respective vehicle; and a road condition database server.

The measuring unit will at least have: a vehicle movement sensor: operable to measure a vehicle movement quantity associated with a present road condition; a positioning unit, operable to record a position at which the measurement is performed; a communication unit, operable to communicate data to said road condition database server.

The road condition database server will have at least a receiver for receiving data from the measuring unit(s), and a memory.

The system will be operable to assign a RCC, out of a limited number of RCCs, to a position, as earlier described based on measured vehicle movement quantities being compared with type calibration data; possibly to store a measurement time; store positions and assigned RCCs and possibly measurement times in a RCD in the memory; and the RCD server being further operable to determine and present a CRCC from a road condition distribution, as earlier described.

Another aspect is a computer program, which causes a processing circuitry to: obtain a plurality of positions and thereto assigned RCCs; store positions and assigned RCCs in a RCD; determine a CRCC, for a target road section or a target area, by forming a distribution of stored RCCs in the ways earlier described; and present the CRCC.

Yet another aspect is a computer program product on which a computer program is stored that when executed measure movements, records positions and assigns RCCs as described earlier, and either communicates positions and RCCs to a RCD or stores these data in a RCD where CRCC data are obtained in ways earlier described, and different road condition data are presented for a target road section or a target area.

1-20. (canceled)

21. A method for obtaining road condition information comprising the steps of:
measuring, by a measuring unit mounted at a vehicle, a vehicle movement quantity associated with a present road condition, at a plurality of occasions;
recording, by said measuring unit, a respective position at which said step of measuring was performed for said plurality of occasions; and
assigning a road condition class, out of a number of pre-defined road condition classes, to each of said positions, based on said measured vehicle movement quantities by comparison with type calibration data;
said type calibration data being pre-defined relations between vehicle movement quantities and road condition classes for a specific type of measuring unit, to which said measuring unit belongs, and for a specific type of vehicle, to which said vehicle belongs.

22. The method according to claim 21, comprising the further steps of:
storing said positions and said thereto assigned road condition classes in a road condition database;
determining a consolidated road condition class, out of said predefined number of road condition classes, for a target road section or a target area, by forming a distribution of stored road condition classes for positions within said target road section or said target area and selecting said consolidated road condition class to be representative for said distribution of road condition classes; and
presenting said consolidated road condition class for said target road section or said target area.

23. The method according to claim 21, comprising the further steps of:
storing said position and said associated road condition in a memory in said measuring unit; and
communicating said positions and said assigned road condition classes to a road condition database server;
whereby said step of communicating is performed intermittently, collectively for a plurality of positions and associated road condition classes.

24. The method according to claim 21, wherein said movement quantity is a quantity quantifying vibrations.

25. The method according to claim 21, wherein said step of recording a respective position comprises positioning by use of a satellite-based navigation system.

26. The method according to claim 21, further comprising the step of:
assigning a measurement time to each said position and said assigned road condition class.

27. The method according to claim 22, further comprising the step of:
assigning a measurement time to each said position and said assigned road condition class;
wherein said step of storing further comprises storing of said assigned measurement times in connection with respective said position and said assigned road condition class.

28. The method according to claim 22, wherein said consolidated road condition class is determined as a rounded off weighted average of said distribution of stored road condition classes.

29. The method according to claim 22, comprising the further step of providing a representation of said distribution of stored road condition classes together with said presentation of said consolidated road condition class.

30. The method according to claim 22, wherein said step of determining a consolidated road condition class is repeated for different target road sections or target areas and/or optionally different target time periods, wherein said step of presenting and said step of providing are performed collectively for said different target road sections or target areas and/or optionally different target time periods

31. A method for analyzing road condition information comprising the steps of:
obtaining a plurality of positions and thereto assigned road condition classes;
storing said positions and said thereto assigned road condition classes in a road condition database;
determining a consolidated road condition class, out of said predefined number of road condition classes, for a target road section or a target area, by forming a distribution of stored road condition classes for positions within said target road section or said target area and selecting said consolidated road condition class to be representative for said distribution of road condition classes; and
presenting said consolidated road condition class for said target road section or said target area.

32. The method according to claim 31, wherein said step of obtaining a plurality of positions and thereto assigned road condition classes comprises receiving said plurality of positions and thereto assigned road condition classes from measurement units.

33. The method according to claim 31, wherein said step of obtaining a plurality of positions and thereto assigned road condition classes comprises receiving a plurality of positions and thereto associated measurements of a vehicle movement quantity associated with a present road condition, and by the further step of:
assigning a road condition class, out of a number of pre-defined road condition classes, to each of said positions, based on said measured vehicle movement quantities by comparison with type calibration data;
said type calibration data being pre-defined relations between vehicle movement quantities and road condition classes for a specific type of measuring unit, to which said measuring unit belongs, and for a specific type of vehicle, to which said vehicle belongs.

34. The method according to claim 31, wherein said step of obtaining a plurality of positions and thereto assigned road condition classes further comprises obtaining of a respective measurement time associated with each of said positions and said assigned road condition classes.

35. The method according to claim 31, wherein said step of determining a consolidated road condition class is performed for positions within said target road section or said target area where respective road condition class is based on vehicle movement quantities measured within a target time period.

36. The method according to claim 31, wherein said consolidated road condition class is determined as a rounded off weighted average of said distribution of stored road condition classes.

37. The method according to claim 31, comprising the further step of providing a representation of said distribution of stored road condition classes together with said presentation of said consolidated road condition class.

38. The method according to claim 31, wherein said step of determining a consolidated road condition class is repeated for different target road sections or target areas and/or optionally different target time periods, wherein said step of presenting and said step of providing are performed collectively for said different target road sections or target areas and/or optionally different target time periods

39. A system for monitoring road conditions comprising:
at least one measuring unit, being mountable at a respective vehicle; and
a road condition database server;
said measuring unit having a vehicle movement sensor, operable to measure a vehicle movement quantity associated with a present road condition;
said measuring unit further having a positioning unit, operable to record a position at which a measurement of said vehicle movement sensor was performed;
said measuring unit further having a communication unit, operable to communicate data to said road condition database server;
said road condition database server having a receiver for receiving data from said measuring units, and a memory;
said system being operable to assign a road condition class, out of a limited number of road condition classes, to said position, based on said measured vehicle movement quantities by comparison with type calibration data;
said type calibration data being pre-defined relations between vehicle movement quantities and road condition classes for a specific type of measuring unit, to which respective said measuring unit belongs, and for a specific type of vehicle, to which respective said vehicle belongs;
said road condition database server being operable to store, in said memory, said positions and said thereto assigned road condition classes in a road condition database;
said road condition database server being further operable to determine a consolidated road condition class, out of said predefined number of road condition classes, for a target road section or a target area, by forming a distribution of stored road condition classes for positions within said target road section or said target area and selecting said consolidated road condition class to be representative for said distribution of road condition classes;
said road condition database server being further operable to present said consolidated road condition class for said target road section or said target area.
